(19) United States
(12) Patent Application Publication
(10) Pub. No.: US 2023/0299430 A1
(43) Pub. Date: Sep. 21, 2023

(54) METHOD FOR MANUFACTURING JOINED BODY, JOINED BODY, AND BATTERY MODULE

(71) Applicants: TOYOTA JIDOSHA KABUSHIKI KAISHA, Toyota-shi Aichi-ken (JP); Amada Co., Ltd., Isehara-shi (JP); Amada Weld Tech Co., Ltd., Isehara-shi Kanagawa (JP); Prime Planet Energy & Solutions, Inc., Chuo-ku Tokyo (JP)

(72) Inventors: Akio Sato, Toyota-shi Aichi-ken (JP); Yasuo Sawai, Isehara-shi Kanagawa-ken (JP); Kazuki Igarashi, Isehara-shi Kanagawa-ken (JP); Haruhiko Yamamoto, Takasago-shi Hyogo-ken (JP)

(73) Assignees: TOYOTA JIDOSHA KABUSHIKI KAISHA, Toyota-shi Aichi-ken (JP); Amada Co., Ltd., Isehara-shi Kanagawa (JP); Amada Weld Tech Co., Ltd., Isehara-shi Kanagawa (JP); Prime Planet Energy & Solutions, Inc., Chuo-ku Tokyo (JP)

(21) Appl. No.: 18/101,794

(22) Filed: Jan. 26, 2023

(30) Foreign Application Priority Data
Mar. 16, 2022 (JP) 2022-041400

(51) Int. Cl. H01M 50/528; B23K 26/323; B23K 26/22; H01M 50/522; H01M 50/526; H01M 50/516; H01M 50/562; H01M 50/566

(52) U.S. Cl. CPC H01M 50/528; B23K 26/323; B23K 26/22; H01M 50/522; H01M 50/526; H01M 50/516; H01M 50/562; H01M 50/566

(57) ABSTRACT

A laminate is formed by overlapping at least a part of a first member and at least a part of a second member. The first member and the second member are joined by irradiating the laminate with a laser. The first member contains aluminum. The second member contains copper. The second member includes a first main surface and a second main surface. The second main surface is an opposite surface of the first main surface. A contact portion is provided due to contact of the first main surface with the first member. The second main surface is irradiated with the laser. A temperature of the contact portion is equal to or higher than an eutectic point temperature of Al and Cu and lower than a melting point of Cu.

### CROSS-REFERENCE TO RELATED APPLICATION

This application claims priority to Japanese Patent Application No. 2022-041400 filed on Mar. 16, 2022, incorporated herein by reference in its entirety.

### BACKGROUND

### 1. Technical Field

The present disclosure relates to a method for manufacturing a joined body, a joined body, and, a battery module.

### 2. Description of Related Art

Japanese Unexamined Patent Application Publication No. 2015-211981 (JP 2015-211981 A) discloses a dissimilar metal joined body.

### SUMMARY

For example, in the field of a battery module and the like, an aluminum (Al) material and a copper (Cu) material are joined together. For example, a bus bar (Al material) may be joined to a negative terminal (Cu material).

For example, the Al material and the Cu material are laminated to form a laminate. Conventionally, a joining layer is formed between the Al material and the Cu material by irradiating the laminate from the Al material side with a laser (see, for example, JP 2015-211981 A). The joining layer joins the Al material and the Cu material. The joining layer contains an Al—Cu alloy.

In order to form the joining layer, both Al and Cu are required to melt at a contact portion between the Al material and the Cu material. Cu has a much higher melting point than Al. As the temperature of the contact portion rises until Cu melts, a large amount of Al melts around the contact portion. It is difficult to control the melting amount of Al such that the melting amount thereof is small while Cu is caused to melt. Spatter may occur due to rapid melting of Al.

When a large amount of Al melts, a brittle Al—Cu alloy tends to precipitate. Further, the joining layer can grow to be thick. The joining layer may not be layered but may have a bumpy shape. The thick joining layer tends to contain cracks in an alloy structure. As a result, joint strength may decrease.

The present disclosure is to provide a dissimilar metal joined body.

A technical configuration and effects of the present disclosure will be described below. However, an effect mechanism of the present specification includes speculation. The effect mechanism does not limit the technical scope of the present disclosure.
1. A first aspect of the present disclosure relates to a method for manufacturing a joined body including:
   a first step of forming a laminate by overlapping at least a part of a first member and at least a part of a second member; and
   a second step of joining the first member and the second member by irradiating the laminate with a laser.

The first member contains aluminum. The second member contains copper.

The second member includes a first main surface and a second main surface. The second main surface is an opposite surface of the first main surface.

In the first step, a contact portion is provided due to contact of the first main surface with the first member.

In the second step, the second main surface is irradiated with the laser, and a temperature of the contact portion is equal to or higher than an eutectic point temperature of the aluminum and the copper and is lower than a melting point of the copper.

Hereinafter, the “first member containing Al” can be abbreviated as an “Al material”. The “second member containing Cu” can be abbreviated as a “Cu material”.

In the present disclosure, the Al material and the Cu material are joined by heat conduction welding. The second member (Cu material) is irradiated with the laser. The laser irradiation raises the temperature of the contact portion between the Al material and the Cu material to the eutectic point temperature of Al and Cu.

At the eutectic point temperature, an eutectic reaction can occur. The eutectic reaction is a reaction in which two solid phases are generated by decomposition of one liquid phase during a cooling process of an alloy melt. The eutectic point temperature is lower than a melting point of each component.

When the temperature of the contact portion reaches the eutectic point temperature, an eutectic melt is generated at the interface between the Al material and the Cu material. That is, both Al and Cu can melt at temperatures below the melting points of Al and Cu. Since the eutectic melt is generated at the interface between the Al material and the Cu material, it is expected that the melting amount of Al will be small. However, when the temperature of the contact portion rises to the melting point of Cu, it is considered that a large amount of Al begins to melt. Therefore, a laser irradiation condition (scanning speed, power, etc.) is adjusted such that the temperature of the contact portion is lower than the melting point of Cu. As a result, the contact portion is heated without the melt of Cu penetrating the Cu material. With solidification of the eutectic melt after heating, a thin joining layer can be formed at the interface between the Al material and the Cu material. The thin joining layer is less likely to contain cracks. Further, the thin joining layer can contain a tough Al—Cu alloy. Therefore, the joining strength is expected to improve.

Further, the present disclosure is expected to reduce the spatter. This is because the melting amount of a workpiece is small.
2. In the second step, the temperature of the contact portion may be, for example, equal to or lower than a melting point of the aluminum. In the second step, the temperature of the contact portion may be, for example, equal to or lower than the melting point of pure aluminum containing no impurities.

For example, this is because the melting amount of the Al material can be reduced.
3. The laser may be, for example, a blue laser or a green laser.

The laser may be, for example, a blue laser with a wavelength band of 400 nm or a green laser with a wavelength band of 500 nm.

The blue laser has a high absorption rate of Cu. In the present disclosure, the Cu material is irradiated with the laser. The heating efficiency is expected to improve due to the use of the blue laser.
4. Each of the first member and the second member may be, for example, a plate shaped member.
5. For example, the first member may be a plate shaped member, and the second member may be a wire rod.

The present disclosure can also be applied to joining between the plate shaped member and the wire rod.
6. A second aspect of the present disclosure relates to a joined body including:
a first member containing aluminum;
a second member containing copper; and
a joining layer which is disposed at an interface between the first member and the second member, joins the first member and the second member, and contains an alloy of aluminum and copper. In a cross section orthogonal to a thickness direction of the joining layer, the joining layer has a thickness of 100 μm or less and a width of 300 μm or more.

The joined body according to the second aspect can be manufactured, for example, by the method according to the first aspect. A thin joining layer (alloy) of 100 or less can firmly join the Al material and the Cu material.
7. The joining layer may have an aspect ratio of 10 or more, for example. The “aspect ratio” indicates a ratio of the width to the thickness of the joining layer.

The joining layer having the aspect ratio of 10 or more can firmly join the Al material and the Cu material.
8. For example, the first member may not have a melting mark. For example, the back surface of the first member may not have the melting mark.

In the present disclosure, since the Cu material is irradiated with the laser, the melting mark may not be formed on the Al material. In addition, the second member (Cu material) can have the melting mark.
9. The alloy may consist of an α phase and a θ phase.

With solidification of the eutectic melt, an Al—Cu alloy consisting of the α phase (Al solid solution) and the θ phase (Al₂Cu) can be formed. The Al—Cu alloy can be tougher than Al—Cu alloys containing other alloy phases.
10. A third aspect relates to a battery module including: the joined body; and two or more single batteries. The joined body connects the adjacent single batteries to each other.

The joined body according to the second aspect can be used, for example, for connecting the single batteries in a battery module.
11. For example, a first member may be a positive terminal, and a second member may be a negative terminal.

In the battery module, when the single batteries are connected in series, the Al material and the Cu material can be joined together. Conventionally, for example, a bus bar made of Al connects the positive terminal (Al material) and the negative terminal (Cu material). In the present disclosure, for example, the positive terminal can be directly joined to the negative terminal not via the bus bar. That is, the battery module can have a busbarless structure.
12. For example, a first member may be a positive terminal, and a second member may be a bus bar.

In the present disclosure, a bus bar made of Cu can be used. The bus bar made of Cu can have a lower electrical resistance than the bus bar made of Al.
13. A fourth aspect of the present disclosure relates to a battery pack including: the joined body; and a single battery. A first member is a positive terminal, and a second member is a signal wire.

The method for manufacturing the joined body according to the first aspect of the present disclosure and the joined body according to the second aspect of the present disclosure can also be applied to joining between the positive terminal (plate shaped member) and the signal wire (wire rod).

Hereinafter, embodiments of the present disclosure (hereinafter can be abbreviated as the “present embodiment”) and examples of the present disclosure (hereinafter can be abbreviated as the “present example”) will be described. However, the present embodiment and the present example do not limit the technical scope of the present disclosure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic flowchart of a method for manufacturing a joined body according to the present embodiment;

FIG. 2 is a first schematic cross-sectional view showing an example of a laminate according to the present embodiment;

FIG. 3 is a second schematic cross-sectional view showing an example of a laminate according to the present embodiment;

FIG. 4 is a schematic diagram showing an example of laser irradiation;

FIG. 5 is a phase diagram of an Al—Cu system;

FIG. 6 is a schematic cross-sectional view showing a joined body in the present embodiment;

FIG. 7 is a first schematic cross-sectional view showing an example of a battery module according to the present embodiment;

FIG. 8 is a second schematic cross-sectional view showing an example of a battery module according to the present embodiment;

FIG. 9 is a conceptual diagram showing an example of a battery pack according to the present embodiment;

FIG. 10 shows surface images and cross-sectional images of joined bodies of Manufacturing Examples 1 to 3; and

FIG. 11 shows cross-sectional images and compositional analysis results of Manufacturing Example 3.

### DETAILED DESCRIPTION OF EMBODIMENTS

### Definitions of Terms

Statements of “comprising,” “including,” and “having,” and variations thereof (for example “composed of”) are open-ended format. The open-ended format may or may not include an additional element in addition to a required element. A statement of “consisting of” is a closed format. However, even when the statement is the closed format, normally associated impurities and additional elements irrelevant to the disclosed technique are not excluded. A statement “substantially consisting of” is a semi-closed format. The semi-closed format allows addition of an element that does not substantially affect the basic and novel characteristics of the disclosed technique.

For multiple steps, actions, operations, and the like included in various methods, the execution order thereof is not limited to the described order unless otherwise specified. For example, the multiple steps may proceed concurrently. For example, the multiple steps may occur one after the other.

Expressions such as “may” and “can” are used in the permissive sense of “having the possibility of” rather than in the obligatory sense of “must”.

For example, numerical ranges such as “m % to n %” include upper and lower limit values unless otherwise specified. That is, “m % to n %” indicates a numerical range of “m % or more and n % or less”. In addition, “m % or more and n % or less” includes “more than m % and less than n %”. Further, a numerical value selected as appropriate from within the numerical range may be used as a new upper limit value or a new lower limit value. For example, a new numerical range may be set by appropriately combining numerical values within the numerical range with numerical values described in other parts of the present specification, tables, drawings, and the like.

All numerical values are modified by the term “approximately.” The term “approximately” can mean, for example, ±5%, ±3%, ±1%, and the like. All numerical values can be approximations that may vary depending on the mode of use of the disclosed technique. All numerical values can be displayed with significant digits. A measured value can be an average value of multiple measurements. The number of measurements may be three or more, five or more, or ten or more. In general, it is expected that the reliability of the average value improves as the number of measurements increases. The measured value can be rounded by rounding based on the number of significant digits. The measured value can include errors and the like associated with, for example, the detection limit of a measuring device.

Geometric terms (for example, “parallel”, “perpendicular”, and “orthogonal”) are not to be taken in a strict sense. For example, “parallel” may deviate somewhat from “parallel” in a strict sense. The geometric terms in the present specification can include tolerances, errors, and the like regarding, for example, designing, working, and manufacturing of products. Dimensional relationships in each drawing may not match actual dimensional relationships. The dimensional relationships (length, width, thickness, etc.) in each drawing may be changed to facilitate understanding of the disclosed technique. Further, a part of the configuration may be omitted.

A “plan view” indicates viewing an object with a line of sight parallel to a thickness direction of the object.

Method for Manufacturing Joined Body

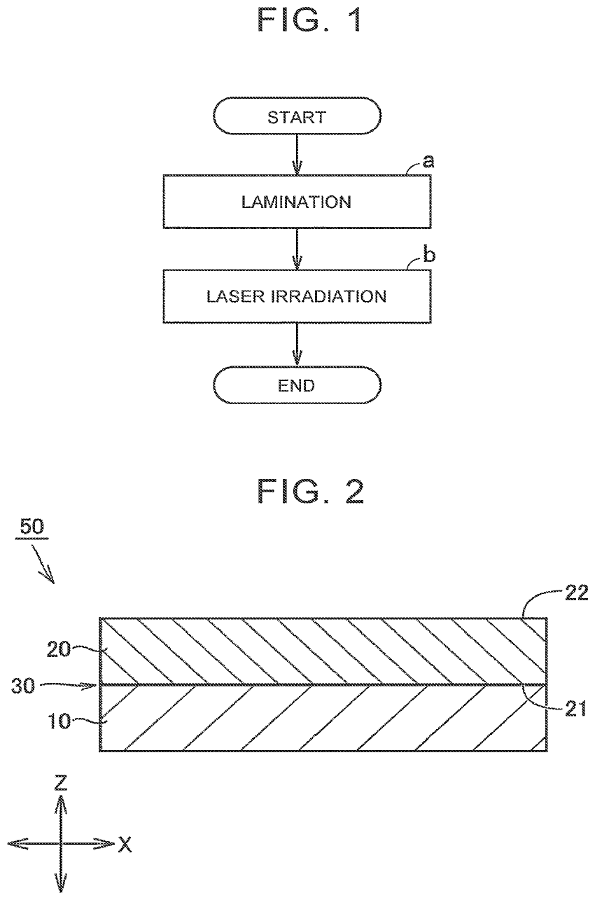

FIG. 1 is a schematic flowchart of a method for manufacturing a joined body according to the present embodiment. Hereinafter, the “method for manufacturing the joined body according to the present embodiment” can be abbreviated as the “manufacturing method”. The manufacturing method includes “(a) lamination” and “(b) laser irradiation”.

(a) Lamination

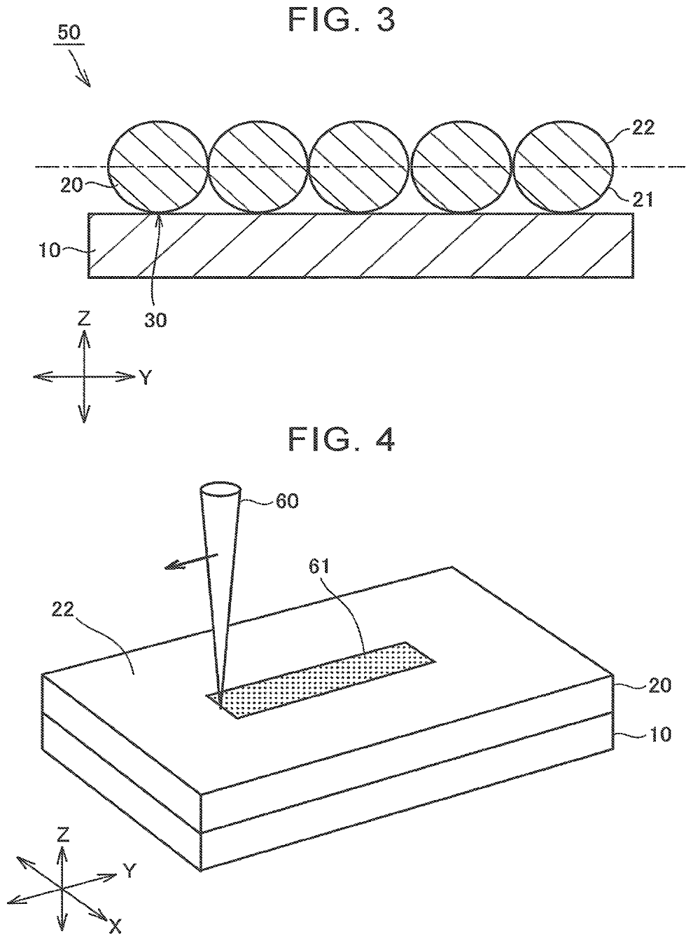

FIG. 2 is a first schematic cross-sectional view showing an example of a laminate according to the present embodiment. The manufacturing method includes forming a laminate 50 by overlapping at least a part of a first member 10 and at least a part of a second member 20. The first member 10 and the second member 20 may overlap partially or entirely.

The second member 20 includes a first main surface 21 and a second main surface 22. The second main surface 22 is an opposite surface of the first main surface 21. The second member 20 and the first member 10 are overlapped such that the first main surface 21 contacts the first member 10. The entire first main surface 21 may contact the first member 10, or a part of the first main surface 21 may contact the first member 10. That is, the second member 20 and the first member 10 are overlapped such that at least a part of the first main surface 21 is in contact with the first member 10. A contact portion 30 is provided due to contact of the first main surface 21 with the first member 10.

The first member 10 may be, for example, a plate shaped member. The first member 10 may be, for example, a positive terminal. For example, the first member 10 may have a thickness of 0.01 mm to 10 mm, a thickness of 0.1 mm to 1 mm, or a thickness of 0.2 mm to 0.6 mm.

The first member 10 contains aluminum (Al). The first member 10 may be made of pure Al, for example. The first member 10 may be made of an Al alloy, for example. The surface of the first member 10 may be plated with nickel (Ni), for example. The first member 10 may contain, in mass fraction, for example, 0.1% to 10% of alloying elements, and the balance Al and unavoidable impurities. The first member 10 may contain, in mass fraction, for example, 0.1% to 5% of alloying elements, and the balance Al and unavoidable impurities. The first member 10 may contain, in mass fraction, for example, 0.1% to 1% of alloying elements, and the balance Al and unavoidable impurities. The alloying elements may contain at least one selected from the group consisting of, for example, silicon (Si), iron (Fe), copper (Cu), manganese (Mn), magnesium (Mg), zinc (Zn), chromium (Cr), and titanium (Ti).

The second member 20 may be, for example, a plate shaped member. The second member 20 may be, for example, a negative terminal. For example, the second member 20 may have a thickness of 0.01 mm to 10 mm, a thickness of 0.1 mm to 1 mm, or a thickness of 0.2 mm to 0.6 mm.

The second member 20 contains copper (Cu). The second member 20 may be made of pure Cu. The second member 20 may be made of a Cu alloy, for example. The surface of the second member 20 may be plated with Ni, for example. The second member may contain, in mass fraction, for example, 0.1% to 20% of alloying elements, and the balance Cu and unavoidable impurities. The second member 20 may contain, in mass fraction, for example, 0.1% to 10% of alloying elements, and the balance Cu and unavoidable impurities. The second member 20 may contain, in mass fraction, for example, 0.1% to 5% of alloying elements, and the balance Cu and unavoidable impurities. The second member may contain, in mass fraction, for example, 0.1% to 1% of alloying elements, and the balance Cu and unavoidable impurities. The alloying elements may contain at least one selected from the group consisting of, for example, beryllium (Be), Ni, Ti, Mn, Fe, Cr, lead (Pb), Zn, Al, tin (Sn), Si, and phosphorus (P).

FIG. 3 is a second schematic cross-sectional view showing an example of a laminate according to the present embodiment. For example, at least one of the first member and the second member 20 may be a wire rod. For example, the second member 20 may be a wire rod. FIG. 3 shows, as an example, a form in which the second member 20 is a wire rod. The wire rod may be, for example, an electric wire. The wire rod may be, for example, a signal wire. The wire rod may be, for example, a single wire or a stranded wire. For example, the wire rod may have a diameter of 0.01 mm to 10 mm, a diameter of 0.1 mm to 1 mm, or a diameter of 0.2 mm to 0.6 mm.

For example, when the second member 20 is a wire rod, half of the outer peripheral surface of the wire rod is regarded as the first main surface 21. The rest of the outer peripheral surface excluding the first main surface 21 is regarded as the second main surface 22.

(b) Laser Irradiation

The manufacturing method includes joining the first member 10 and the second member 20 by irradiating the laminate 50 with a laser 60. A joined body is manufactured by joining the first member 10 and the second member 20.

FIG. 4 is a schematic diagram showing an example of laser irradiation. A Cu material is irradiated with the laser 60. That is, the second main surface 22 is irradiated with the laser 60. Scanning is performed with the laser 60 along the second main surface 22. Scanning may be performed with the laser 60, for example, to draw a linear trajectory. Scanning may be performed with the laser 60, for example, to draw a meandering trajectory. Scanning may be performed with the laser 60, for example, to draw a spiral trajectory. Scanning may be performed with the laser 60, for example, to draw a screw-shaped trajectory. When a workpiece is a wire rod, for example, scanning may be performed with the laser 60 in the diameter direction of the wire rod.

A scan mark of the laser 60 may be formed on the second main surface 22. The scan mark may be a streaky melting mark 61. A streak can be formed when a melt solidifies. The melting mark 61 may be, for example, discoloration. The melting mark 61 may be, for example, surface roughness (unevenness). The melting mark 61 may be, for example, a work-hardened layer. For example, a scan direction of the laser 60 may be specified from the orientation, shape, etc. of the melting mark 61.

The second member 20 is heated by irradiation with the laser 60. Heat conduction in the second member 20 heats the contact portion 30. A condition of irradiation with the laser 60 is adjusted such that the maximum temperature (reaching temperature) of the contact portion 30 is equal to or higher than the eutectic point temperature of Al and Cu and is lower than the melting point of Cu during the irradiation with the laser 60.

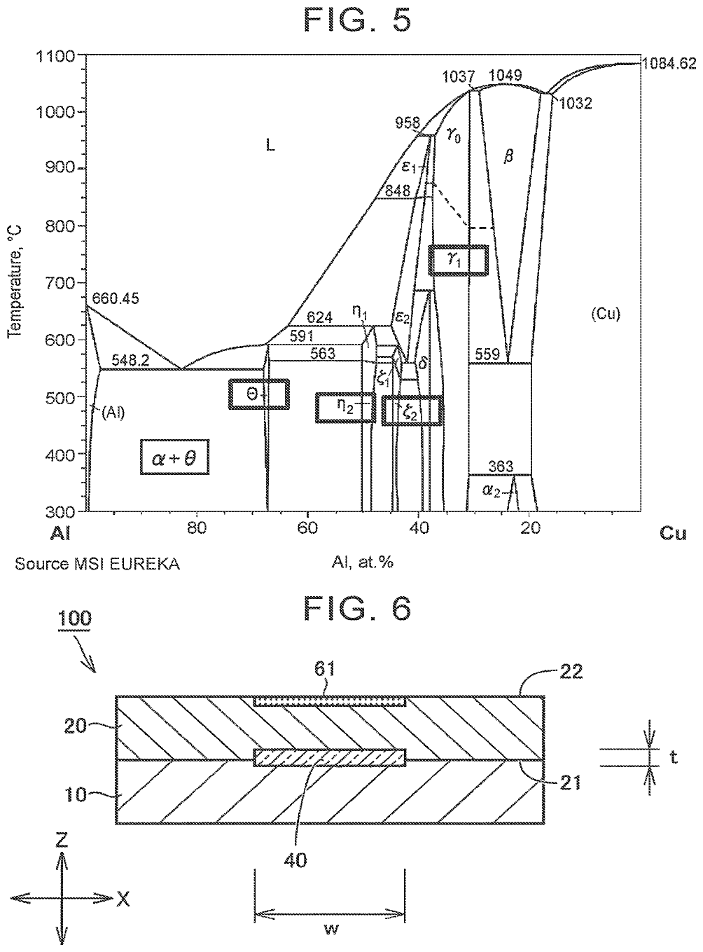

FIG. 5 is a phase diagram of an Al—Cu system. When the temperature of the contact portion 30 becomes equal to or higher than the eutectic point temperature (548.2° C.), the α-phase (Al solid solution) and the 0-phase (Al₂Cu) react to form an eutectic melt. The eutectic melt is thinly formed at the contact portion 30 (interface). A joining layer is formed due to solidification of the eutectic melt.

The temperature of the contact portion 30 is adjusted below the melting point of Cu (1084.62° C.) such that Cu does not easily melt. This is because when Cu starts to melt, a large amount of Al can melt. The temperature of the contact portion 30 may be adjusted to the melting point of Al (660.45° C.) or lower. This is because the melting amount of Al can be reduced.

For example, the temperature of the contact portion 30 can be adjusted by a combination of the power, the scanning speed, the scanning pattern, the wavelength, and the beam diameter of the laser 60. The power of the laser 60 may be, for example, 500 W to 3000 W or 1000 W to 2000 W. The scanning speed of the laser 60 may be, for example, 10 mm/min to 200 mm/min, 50 mm/min to 100 mm/min, 50 mm/min to 80 mm/min, or 80 mm/min to 100 mm/min. The beam diameter may be, for example, 0.1 mm to 1 mm or 0.4 mm to 0.8 mm.

The laser 60 may include, for example, at least one selected from the group consisting of a blue laser and a green laser. The laser 60 may be, for example, the blue laser or the green laser. That is, the wavelength of the laser 60 may be, for example, 445 nm to 532 nm. The blue laser and the green laser have a high absorption rate of Cu. The blue laser has a particularly high absorption rate of Cu. The heating efficiency is expected to improve due to the use of the blue laser. The wavelength of the laser 60 may be, for example, 445 nm to 455 nm.

Joined Body

FIG. 6 is a schematic cross-sectional view showing the joined body in the present embodiment. A joined body 100 includes the first member 10, the second member and a joining layer 40. Details of the first member 10 and the second member 20 are as described above. The joining layer 40 is disposed at the interface between the first member and the second member 20. The first member 10 and the second member 20 are joined together by the joining layer 40.

The joining layer 40 is thinly formed at the interface between the first member 10 and the second member 20. The thin joining layer 40 tends not to contain cracks in the alloy structure. FIG. 6 shows a cross section orthogonal to the thickness direction (Z-axis direction) of the joining layer 40. A thickness t indicates the maximum dimension in the thickness direction. The joining layer 40 has the thickness t of 100 μm or less. The thickness t may be, for example, 50 μm or less, or 30 μm or less. The thickness t may be, for example, 1 μm or more, 5 μm or more, 10 μm or more, or 20 μm or more.

A width w is orthogonal to the thickness t. The width w indicates the maximum dimension in a direction orthogonal to the thickness direction. The width w is also orthogonal to the scan direction of the laser. In FIG. 6, scanning is performed with the laser in the Y-axis direction (direction perpendicular to the plane of the drawing). The width w is also orthogonal to a direction in which the joining layer 40 extends in a plan view (XY plane). The joining layer 40 may have the width w of 300 μm or more, for example. The joining strength is expected to improve as the width w increases. The width w may be, for example, 500 μm or more, or 1 mm or more. The width w may be, for example, 5 mm or less, or 3 mm or less.

The joining layer 40 may have an aspect ratio of 10 or more, for example. The aspect ratio (w/t) is a ratio of the width w to the thickness t. The aspect ratio may be, for example, 30 or more, or 50 or more. The aspect ratio may be, for example, 1000 or less, or 100 or less.

The joining layer 40 contains the Al—Cu alloy. The Al—Cu alloy can be tough. The Al—Cu alloy may consist of, for example, the α phase and the 0 phase. The Al—Cu alloy may not contain phases other than the α phase and the 0 phase. Phases other than the α phase and the θ phase include, for example, the γ₂ phase (Al₄Cu₉), the ζ₂ phase (Al₃Cu₄), and the η₂ phase (AlCu). For example, when a large amount of Al melts during laser irradiation, the γ₂ phase, the ζ₂ phase, the η₂ phase, etc. can precipitate. The joining layer 40 that includes the γ₂ phase, the ζ₂ phase, the η₂ phase, etc. tends to be brittle.

The Al—Cu alloy may contain, in atomic fraction, for example, 67% to 99% of Al and the balance Cu. The Al—Cu alloy may contain, in atomic fraction, for example, 70% to 95% of Al and the balance Cu. The Al—Cu alloy may contain, in atomic fraction, for example, 75% to 90% of Al and the balance Cu. The Al—Cu alloy may contain, in atomic fraction, for example, 80% to 85% of Al and the balance Cu.

The composition of the joining layer 40 can be specified by a scanning electron microscope energy dispersive X-ray spectrometry (SEM-EDX), an electron probe micro analyzer (EPMA), or the like.

In the manufacturing method, the second member 20 is irradiated with the laser. The melting mark 61 (streak, discoloration, unevenness, etc.) can be formed on the surface of the second member 20 (the second main surface 22). On the other hand, in the first member 10, the melting mark 61 is less likely to be formed. For example, the first member may not have the melting mark 61. For example, the back surface of the first member 10 may not have the melting mark 61. The back surface indicates a surface opposite to the surface facing the second member 20.

The joining strength between the first member 10 and the second member may be equal to or greater than the strength of a base material. The base material indicates the first member 10 and the second member 20. That is, for example, when force is applied in a direction in which the first member 10 is separated from the second member 20, the joining layer 40 may not be broken, and the first member 10 or the second member 20 may be broken. The joining strength may be, for example, 20 N/mm² or more, 30 N/mm² or more, or 40 N/mm² or more. The joining strength may be, for example, 100 N/mm² or less.

First Battery Module

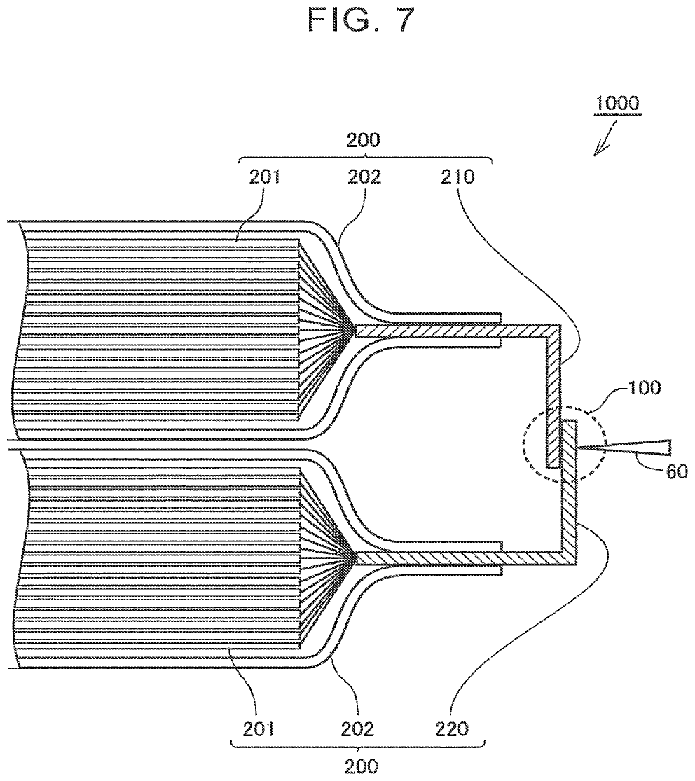

FIG. 7 is a first schematic cross-sectional view showing an example of a battery module according to the present embodiment. A first battery module 1000 includes the joined body 100 and two or more single batteries 200 (cells). The first battery module 1000 may include, for example, 2 to 100 single batteries 200, 2 to 50 single batteries 200, or 2 to 30 single batteries 200.

The single battery 200 can have any structure. The single battery 200 may be, for example, a lithium ion battery. The single battery 200 may contain an electrolytic solution, for example. The single battery 200 may be, for example, an all solid-state battery. The single battery 200 may include an exterior body 202, for example. The exterior body 202 may be, for example, a pouch made of an Al-laminated film or a case made of an Al alloy. The exterior body 202 accommodates an electrode group 201. The single battery 200 includes a positive terminal 210 and a negative terminal 220. Each of the positive terminal 210 and the negative terminal 220 is electrically connected to the electrode group 201. The positive terminal 210 and the negative terminal 220 extend from the inside of the exterior body 202 to the outside thereof. The positive terminal 210 and the negative terminal 220 are plate shaped members. A plate-shaped electrode terminal can also be referred to as an “electrode tab (positive tab, negative tab)”.

Adjacent single batteries 200 are electrically connected in series. The first battery module 1000 has a busbarless structure. The positive terminal 210 and the negative terminal 220 are directly connected between the adjacent single batteries 200. The positive terminal 210 contains Al. The negative terminal 220 contains Cu. That is, the first member is the positive terminal 210 and the second member is the negative terminal 220. The positive terminal 210 and the negative terminal 220 form the joined body 100. The joined body 100 connects the adjacent single batteries 200 to each other. The joined body 100 can be formed by irradiation with the laser 60 from the negative terminal 220 (Cu material) side.

Second Battery Module

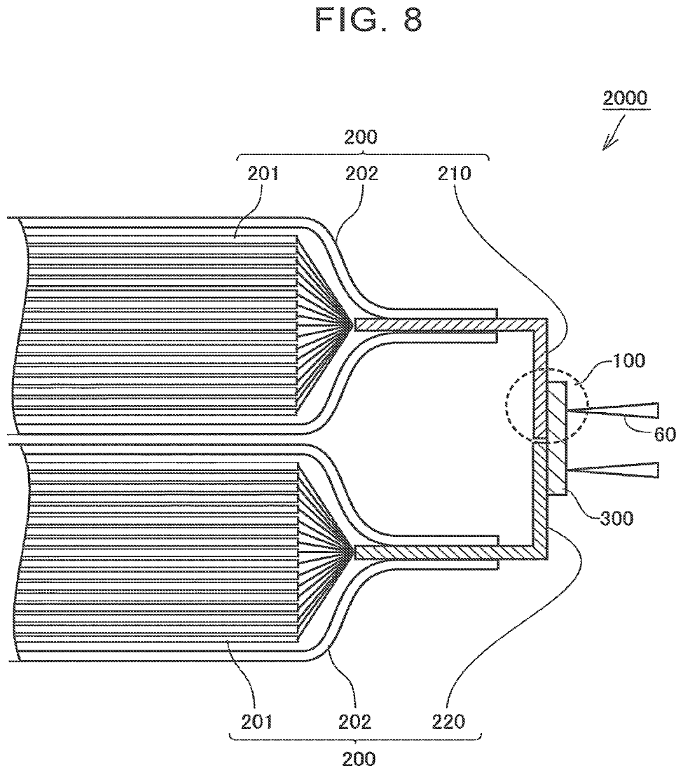

FIG. 8 is a second schematic cross-sectional view showing an example of a battery module according to the present embodiment. A second battery module 2000 includes the joined body 100 and two or more single batteries 200. The second battery module 2000 includes a bus bar 300. The bus bar 300 is joined to the positive terminal 210. The bus bar 300 is also joined to the negative terminal 220. The bus bar 300 connects the positive terminal 210 and the negative terminal 220. The positive terminal 210 contains Al. The negative terminal 220 contains Cu. The bus bar 300 contains Cu. That is, the first member is the positive terminal 210 and the second member is the bus bar 300. The positive terminal 210 and the bus bar 300 form the joined body 100. The joined body 100 connects the adjacent single batteries 200 to each other. The joined body 100 can be formed by irradiation with the laser 60 from the bus bar 300 (Cu material) side.

Note that the bus bar 300 and the negative terminal 220 (Cu materials) can be joined by any method. For example, the bus bar 300 may be joined to the negative terminal 220 by irradiation with the laser 60.

Battery Pack

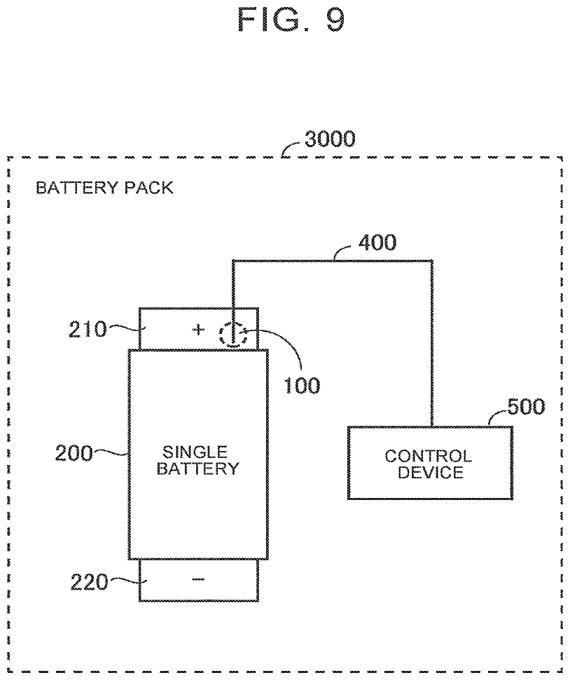

FIG. 9 is a conceptual diagram showing an example of a battery pack according to the present embodiment. A battery pack 3000 includes the joined body 100 and the single battery 200. The battery pack 3000 may include two or more single batteries 200. That is, the battery pack 3000 may include a battery module. The battery pack 3000 may further include, for example, a control device 500, various sensors (not shown), a protection circuit (not shown), a cooling device (not shown), and the like.

The battery pack 3000 includes a signal wire 400. The signal wire 400 can transmit, for example, a current signal, a voltage signal, and the like. The signal wire 400 is joined to the positive terminal 210 of the single battery 200. The positive terminal 210 contains Al. The positive terminal 210 is a plate shaped member. The signal wire 400 contains Cu. The signal wire 400 is a wire rod. That is, the positive terminal 210 and the signal wire 400 form the joined body 100. The signal wire 400 may be connected to the control device 500.

As another form, for example, in a battery pack including a bus bar made of Al, the signal wire (Cu material) may be joined to the bus bar (Al material).

Manufacturing of Joined Body

### Manufacturing Example 1

The following materials were prepared.
First member: positive tab (made of Al, thickness 0.4 mm)
Second member: negative tab (made of Cu, thickness 0.4 mm)

A laminate was formed by laminating the first member and the second member. A joined body was manufactured by irradiation with a laser from the second member side. A laser irradiation condition was as follows.

Laser power: 1500 W
Laser wavelength: 450 nm (blue laser)
Beam diameter: 0.6 mm
Scanning speed: 50 mm/min

### Manufacturing Example 2

A joined body was manufactured in the same manner as in Manufacturing Example 1, except that the scanning speed of the laser was changed to 80 mm/min.

### Manufacturing Example 3

A joined body was manufactured in the same manner as in Manufacturing Example 1, except that the scanning speed of the laser was changed to 100 mm/min.

### Evaluation

A tensile tester was used to measure the joining strength between the first member and the second member. Each joined body had a joint strength equal to or higher than the strength of the base material.

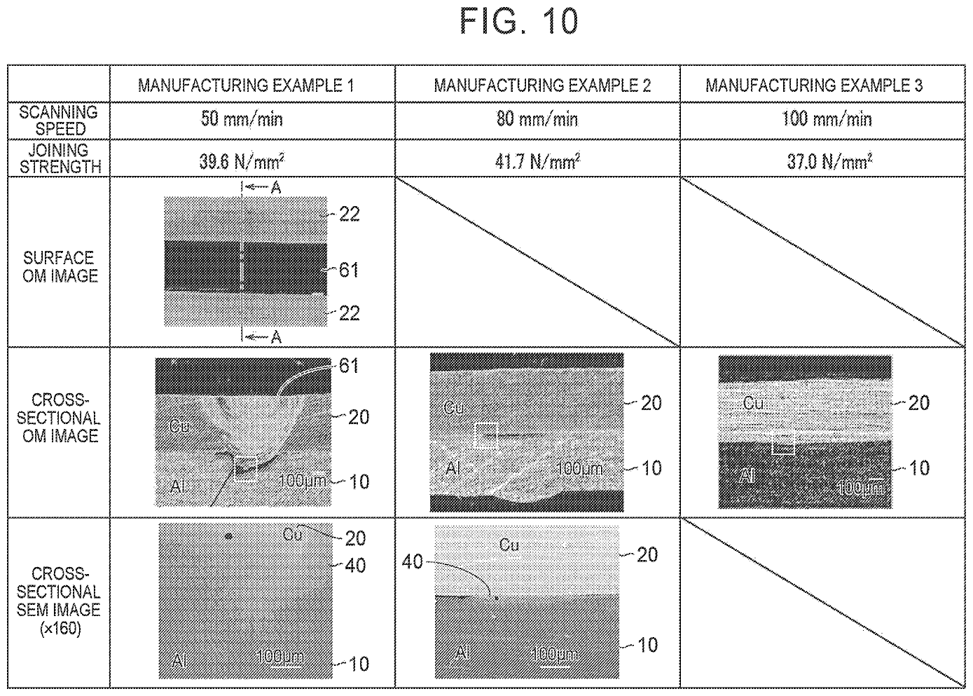

FIG. 10 shows surface images and cross-sectional images of joined bodies of Manufacturing Examples 1 to 3. The surface image shown in FIG. 10 is an optical microscope (OM) image of the second main surface. The cross sections shown in FIG. 10 are orthogonal to the thickness direction of the joining layer. The cross-sectional OM images are captured at the A-A section of the surface OM image. The cross-sectional scanning electron microscope (SEM) images are captured in rectangular areas within the cross-sectional OM images.

In the surface OM image of Manufacturing Example 1, the melting mark 61 (discoloration) is seen along the laser trajectory.

In the cross-sectional OM image of Manufacturing Example 1, the melting mark 61 of copper is seen over a range from the surface of the second member 20 (Cu) to the interface between Cu and Al. A part of copper melts into the first member 10 (Al).

The shading in the cross-sectional SEM image indicates the difference in composition. In the joining layer 40 of Manufacturing Example 1, it is considered that multiple types of alloy phases having different compositions precipitate in multiple layers.

In Manufacturing Examples 2 and 3, the thin joining layer 40 was formed. The aspect ratio of the joining layer 40 was 10 or more.

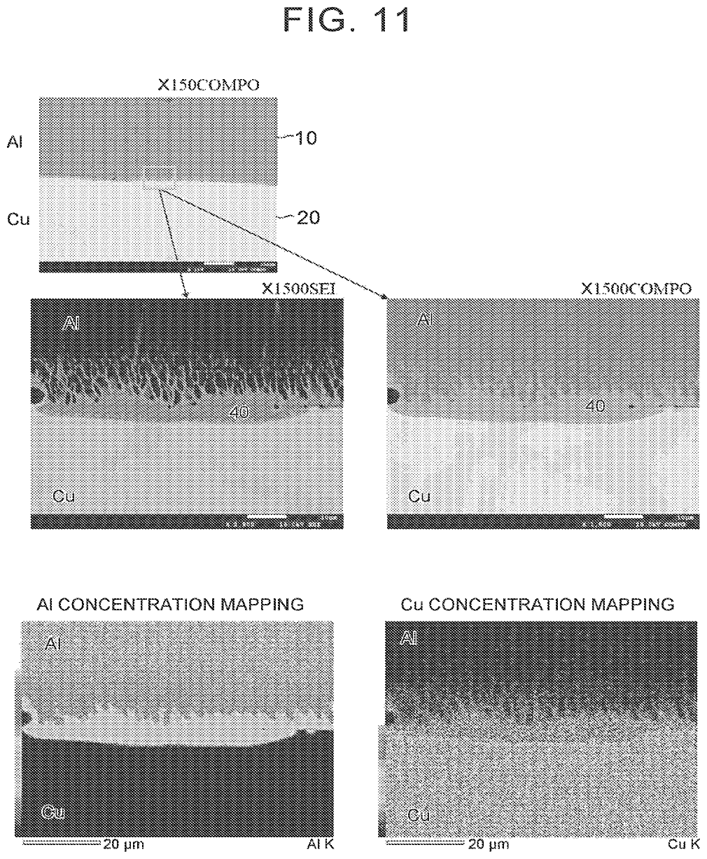

FIG. 11 shows cross-sectional images and compositional analysis results of Manufacturing Example 3. FIG. 11 shows a secondary electron image (SEI) in the rectangular area within the OM image shown in FIG. 10 and a COMPO image (composition image). Note that the images are turned upside down between FIG. 10 and FIG. 11. Further, FIG. 11 shows the Al concentration mapping result in the SEI image and the Cu concentration mapping result in the COMPO image. The joining layer 40 of Manufacturing Example 3 is considered to be substantially single-phase. Further, the joining layer 40 is considered to have a substantially uniform composition.

### APPENDIX

The present specification also supports a “method for manufacturing a battery module” and a “method for manufacturing a battery pack”. The “method for manufacturing a battery module” and the “method for manufacturing a battery pack” each include a “method for manufacturing a joined body”.

The present embodiment and the present example are illustrative in all respects. The present embodiment and the present example are not restrictive. The technical scope of the present disclosure includes all changes within the meaning and range equivalent to the description of the claims. For example, from the beginning, it is planned to extract an appropriate configuration from the present embodiment and the present example and combine them as appropriate.

What is claimed is:

1. A method for manufacturing a joined body, the method comprising:
a first step of forming a laminate by overlapping at least a part of a first member and at least a part of a second member; and
a second step of joining the first member and the second member by irradiating the laminate with a laser, wherein:
the first member contains aluminum;
the second member contains copper;
the second member includes a first main surface and a second main surface;
the second main surface is an opposite surface of the first main surface;
in the first step, a contact portion is provided due to contact of the first main surface with the first member; and
in the second step, the second main surface is irradiated with the laser, and a temperature of the contact portion is equal to or higher than an eutectic point temperature of the aluminum and the copper and is lower than a melting point of the copper.

2. The method according to claim 1, wherein in the second step, the temperature of the contact portion is equal to or lower than a melting point of the aluminum.

3. The method according to claim 1, wherein the laser is a blue laser or a green laser.

4. The method according to claim 1, wherein each of the first member and the second member is a plate shaped member.

5. The method according to claim 1, wherein:
the first member is a plate shaped member; and
the second member is a wire rod.

6. A joined body comprising:
a first member containing aluminum;
a second member containing copper; and
a joining layer which is disposed at an interface between the first member and the second member, joins the first member and the second member, and contains an alloy of aluminum and copper, wherein in a cross section orthogonal to a thickness direction of the joining layer, the joining layer has a thickness of 100 μm or less and a width of 300 μm or more.

7. The joined body according to claim 6, wherein:
the joining layer has an aspect ratio of 10 or more; and
the aspect ratio indicates a ratio of the width to the thickness.

8. The joined body according to claim 6, wherein the first member does not have a melting mark.

9. The joined body according to claim 6, wherein the alloy consists of an α phase and a θ phase.

10. A battery module comprising:
the joined body according to claim 6; and
two or more single batteries, wherein the joined body connects the adjacent single batteries to each other.

11. The battery module according to claim 10, wherein:
a first member is a positive terminal; and
a second member is a negative terminal.

12. The battery module according to claim 10, wherein:
a first member is a positive terminal; and
a second member is a bus bar.
